(19) United States
(12) Patent Application Publication
(10) Pub. No.: US 2017/0349105 A1
(43) Pub. Date: Dec. 7, 2017

(54) Vehicular Caddy

(71) Applicant: Platros LLC, Union City, NJ (US)

(72) Inventors: Stephen Gerard Karrer, E. Rutherford, NJ (US); Jeffrey Cartagena, Union City, NJ (US)

(21) Appl. No.: 15/611,948

(22) Filed: Jun. 2, 2017

Related U.S. Application Data
(60) Provisional application No. 62/344,515, filed on Jun. 2, 2016.

(51) Int. Cl. B60R 7/04; B60N 3/00; B60N 3/10; B60R 16/033

(52) U.S. Cl. CPC B60R 7/043; B60R 16/033; B60N 3/002; B60N 3/104; B60R 7/046

(57) ABSTRACT

In an embodiment of the present invention a vehicular storage system is provided, comprising a storage facility for securing chattels, and a base extending from the storage facility. The base is configured to be securely inserted into an opening in a vehicle and to securely support the storage facility when the base is securely inserted into the opening. The base may include a swivel means to allow the adjustment of the angle of the storage facility. The vehicular storage system may also include a covering and a securing means for stabilizing the storage facility.

### CROSS-REFERENCE TO RELATED APPLICATIONS

The present application claims priority to provisional U.S. patent application Ser. No. 62/344,515, filed Jun. 2, 2016 and entitled “Vehicular Caddy,” the disclosure of which is incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

### 1. Field of the Invention

The present invention relates to a caddy for use in a vehicle and is capable of securely holding, displaying, and storing personal belongings.

### 2. Background

As people travel by various vehicles, such as automobiles, planes, trains, buses, and boats, a need exists for them to place beverages, food containers, cell phones and other personal belongings, in a secure holder or storage device. In addition, a need exists for transportation companies to have the ability to offer their passengers beverages, sticks or packs of chewing gum, mints, candy, hand sanitizer, tissue packets or boxes, bowls of mints, glasses, bags of nuts, and other convenience items. Most vehicles are not equipped with a platform or storage facility to securely hold or elegantly display and offer these convenience items to passengers.

It may be desirable for a passenger to have personal belongings secured in a vehicle to allow the passenger to do other tasks. For example, when the passenger needs to use a computing device, the passenger will want to have any drinks secured to avoid any potential damages from spills onto the computing device.

### BRIEF SUMMARY OF THE INVENTION

An object of the present invention is to provide a vehicular storage system (e.g., vehicular caddy) that enables a user to securely store or hold personal belongings or other chattels when traveling in a vehicle.

In an embodiment of the present invention a vehicular storage system is provided, comprising a storage facility for securing chattels, and a base; wherein the base is configured to be securely inserted into an opening; wherein the storage facility is secured to the base; and wherein the base securely supports the storage facility when the base is securely inserted into the opening.

In another embodiment of the present invention a vehicular storage system is provided, further comprising a thermal system for cooling or heating the chattels.

In another embodiment of the present invention a vehicular storage system is provided, wherein the thermal system further comprises a thermoelectric element and a means for supplying power to the thermoelectric element.

In another embodiment of the present invention a vehicular storage system is provided, wherein the thermal system comprises a means for coupling with a vehicle heating and cooling system.

In another embodiment of the present invention a vehicular storage system is provided, further comprising an electric supply system comprising an electric connector; wherein the electric supply system allows a user to operate or charge electronic devices by coupling the electronic devices to the electric connector.

In another embodiment of the present invention a vehicular storage system is provided, wherein the electric supply system is configured to electrically connect to and utilize one of batteries and a vehicle's electric system.

In another embodiment of the present invention a vehicular storage system is provided, wherein the electric supply system is configured to electrically connect to and utilize a vehicle's electric system as a primary power source and is also configured to electrically connect to and utilize batteries as a secondary power source in the event the vehicle's electric system stops supplying power.

In another embodiment of the present invention a vehicular storage system is provided, wherein the storage facility includes at least one aperture.

In another embodiment of the present invention a vehicular storage system is provided, wherein the base extends substantially_downward from the storage facility; and wherein the opening is a backseat pocket of a vehicle seat.

In another embodiment of the present invention a vehicular storage system is provided, wherein the base and storage facility are configured to allow vertical angular adjustment of the storage facility relative to the base to accommodate different seatback recline positions.

In another embodiment of the present invention a vehicular storage system is provided, wherein the base extends substantially downward from the storage facility; and wherein the opening is a cup holder.

In another embodiment of the present invention a vehicular storage system is provided, wherein the base extends substantially downward from the storage facility; and wherein the opening is a cavity in a vehicle door armrest.

In another embodiment of the present invention a vehicular storage system is provided, wherein the storage facility comprises a dispenser.

In another embodiment of the present invention a vehicular storage system is provided, wherein the storage facility comprises a tray.

In another embodiment of the present invention a vehicular storage system is provided, further comprising a securing means for stabilizing the storage facility.

In another embodiment of the present invention a vehicular storage system is provided, wherein the base includes a swivel means to allow the adjustment of the angle of the storage facility.

In another embodiment of the present invention a vehicular storage system is provided, wherein the base extends in a substantially horizontal plane from the storage facility; and wherein the base is securely inserted into the space formed between a vehicle's seatback and the seat's heard rest.

In another embodiment of the present invention a vehicular storage system is provided, wherein the storage facility comprises a cover; wherein a user can access the aperture when the cover is open and cannot access the aperture when the cover is closed.

### BRIEF DESCRIPTION OF THE SEVERAL VIEWS OF THE DRAWING

The advantages and features of the present invention will be better understood as the following description is read in conjunction with the accompanying drawings, wherein:

FIG. 1 is a perspective view of the front of an embodiment of the present invention.

FIG. 2 is a perspective view of an embodiment of the present invention.

FIG. 3 is a perspective view of an embodiment of the present invention used in the backseat pocket of a vehicle seat.

FIG. 4 is a perspective view of an embodiment used with a headrest of a seat in a vehicle.

### DETAILED DESCRIPTION OF THE INVENTION

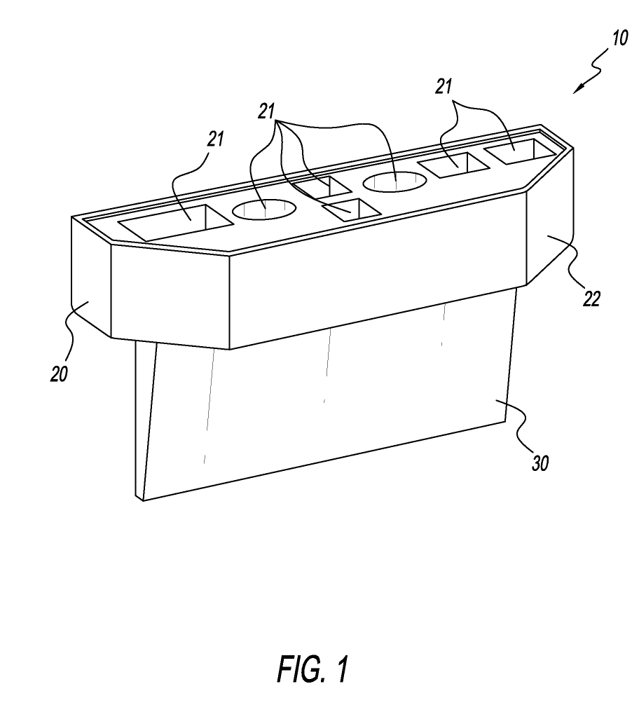

Various embodiments of the present invention are shown in FIGS. 1 through 4. However, the invention is not limited to the described embodiments, and one skilled in the art will appreciate that many other embodiments of the invention are possible without deviating from the basic concept of the invention and that any such work around will also fall under the scope of the invention. It is envisioned that other styles and configurations of the present invention can be easily incorporated into the teachings of the present invention, and only particular configurations shall be shown and described for the purposes of clarity and disclosure and not by way of limitation of scope.

FIG. 1 illustrates an embodiment of the present invention, which is a vehicular caddy 10. Vehicular caddy 10 has a storage facility 20 for securing personal belongings, and a base 30 that extends from the storage facility 20.

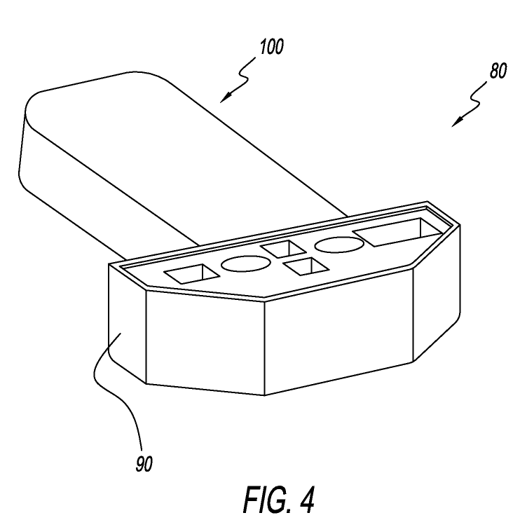

FIG. 4 illustrates another embodiment of the present invention, which is a vehicular caddy 80. Vehicular caddy 80 has a storage facility 90 for securing personal belongings, and a base 100 that extends from the storage facility 90.

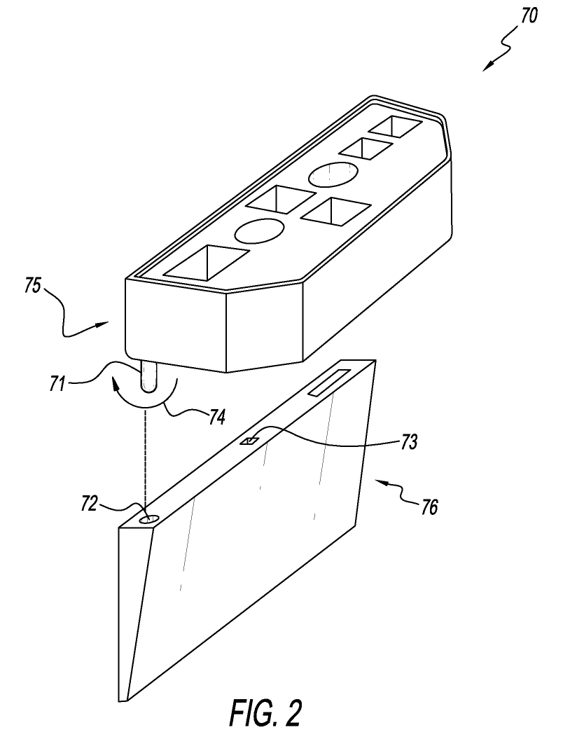

The following disclosure is made with reference to the embodiment disclosed in FIG. 1, however, it is understood that other embodiments, including the embodiments disclosed in FIGS. 2, 3, and 4, will have many of the same features even if they are not expressly described.

The storage facility 20 includes a top surface 23, side surfaces 22, and apertures 21. The storage facility 20 can be round, oval, semi-oval, square, cylindrical, rectangular, triangular, or any other geometric shape. The storage facility 20 can be a solid piece or can be hollow. The storage facility 20 can serve as a box, or storage compartment, into which items may be placed. A box or storage compartment contained within the storage facility 20 can be accessible through the top surface 23 which can be configured to function as a cover, to be fully removable or partially removable (by, e.g., utilizing a hinge mechanism) from the storage facility 20. A separate cover, in addition to the top surface 23, can also be provided, that can be opened or closed, again utilizing a hinge or similar known mechanism. When the cover is open or partially open the chattels stored in the storage facility 20 can be accessed. When the cover is closed it can be used as a tray, work table, laptop surface, etc. The cover can have a non-slip surface to reduce the risk of slippage for items placed on the cover or top surface 23. Non-slip surface can be applied as a coating of non-slip material, such as rubber, silicone, or similar known materials. The non-slip surface can also be formed by providing texture that increases friction with items placed on it and reduces slippage.

A box or storage compartment contained within the storage facility 20 further can be accessible through the side surfaces 22, portions of which can be configured to be fully removable or partially removable (by, e.g., utilizing a hinge mechanism) from the storage facility 20.

The top surface 23 of the storage facility 20 can be a flat surface, creating a platform to hold, display or lay items. It can comprise a raised border (e.g., lip) that may contain liquid spills or prevent small things from falling off the top surface 23.

In accordance with another embodiment of the invention, the vehicular caddy 10 comprises a thermal system capable of heating and/or cooling. The thermal system may utilize electric heating elements (e.g., thermoelectric, resistive, etc.) or cooling elements (e.g., thermoelectric, liquid cooling, refrigerant, etc.). The vehicular caddy 10 can comprise means for supplying power to the heating or cooling elements, including an electric supply system described below. Such means can comprise connectors, power distribution circuits, electric converters controllers, electric wiring, and other similar means known in the art. The means for supplying power can be connected to a power source, such as batteries, solar panels, wind turbines, dynamos, etc., or to the vehicle electric system either through direct wiring, or by utilizing an adapter capable of connecting for example to a vehicle's USB or cigarette lighter adapter, or to another outlet. The heating or cooling elements can also include means for coupling the elements with the vehicle's heating and cooling system. The means for coupling can use flexible or other ducts, tubing, piping, or other methods, to connect to the vehicles temperature control system in such a way as to allow hot or cold air to circulate through the storage facility 20, base 30, or both. Storage facility 20 and base 30 may comprise air escape apertures that allow air circulation with the ambient air.

Electrical power to the vehicular caddy 10 can be supplied by electric supply systems positioned within storage facility 20, base 30, or both. Or the electric supply system can be positioned externally to the vehicular caddy 10. The electric supply systems can comprise various power sources, such as batteries, miniature generators, wind turbines, dynamos, solar panels, and any other electric power source or method of power generation known in the art. The electric supply system can also be placed elsewhere within the vehicle and electrically coupled to the heating or cooling elements, or any other system or device that requires electric power. The electric supply system can also be on the outside of the vehicle, for example to be stored out of the way, or to be able to use solar power, wind power, etc.

Electric power to the vehicular caddy 10 also can be supplied by the vehicle's electrical system. The storage facility 20 or base 30 of the vehicular caddy 10 can utilize an electrical connector that allows it to be electrically connected to any external electric power, such as the electric supply system discussed above, or the vehicle's electric system. In turn, the electrical connector can be electrically coupled to any systems or devices that require electricity in such a way as to supply the necessary electrical power, for example through direct wiring, electrical AC or DC converters, transformers, filters, and similar devices that are known to one skilled in the art.

Electric power to the vehicular caddy 10 may also be supplied by a combination of an electric supply system power source and the vehicle's electrical system, wherein an adapter capable of connection to the electrical system of the vehicle would act as the main source of power and the electric supply system power source would act as a backup source of power. As a result, if the vehicle is turned off, the electric systems and devices of vehicular caddy 10 would still operate with the battery backup.

The vehicular caddy 10 may also include a dispenser, preferably located within the storage facility 20, which may be mechanically or electrically operated (by, e.g., being coupled to the electrical system described above). Transportation companies may want to provide their clients with the option of purchasing convenience items, in which case the vehicular caddy 10 may further comprise a payment terminal. The payment terminal may be coupled to the dispenser.

The electric supply system of the vehicular caddy 10 may also include means to supply external power to the user, for example to allow the user to charge or operate electric or electronic devices. External power to the user can be supplied in the form of one or more electric connectors, such as USB ports, other electronic port, or any other similar electric or electronic outlet connector that will allow charging or operation of electric or electronic devices when the devices are coupled with the connector by connecting a cable between the device and the electric connector. The electric connector can also include a wireless charging surface that allows devices placed on the surface (i.e., coupled with the electric connector) to be wireless charged (e.g., inductively). The means to supply external power can receive electrical power as any other system or device that utilizes electricity, as described herein.

The vehicular caddy 10 may also include a tray, preferably located within the storage facility 20. The tray may be one the can be open vertically, by pulling down or pushing up, swing open side to side, pulled out from the vehicle caddy, or of telescoping construction or any other configuration known in the art. The body of the tray can be stored inside storage facility 20, or base 30, or can be attached to the outside of the vehicular caddy 10, so that when not in use it is folded or stowed away.

The apertures 21 can be spaces, holes or slots for items to be put into and held or for holders or inserts to be put into. The apertures 21 can be round, oval, square, cylindrical, rectangular, triangular, or any other geometric shape.

FIG. 2 illustrates an embodiment of the present invention with a swivel means. The vehicular caddy 70 has a storage facility 75 for securing personal belongings, and a base 76 that extends from the storage facility 75. The swivel means can comprise a pin 71 and a pin aperture 72. The pin 71 is releasably engaged to and may rotate within the pin aperture 72, thereby allowing the storage facility 75 to swivel about the base 76, as illustrated by arrow 74. The swivel means allows the adjustment of the angle of the storage facility 75 in relation to the base 76. The base 76 may optionally have a locking tab aperture 73 and at least one locking tab (not shown) on the underside of the storage facility 75. The locking tab aperture 73 is mated to the locking tab. The storage facility 75 can be lifted to release the locking tab and swiveled about the base 76 to different positions. The swivel means can also be hinge mechanism, or any other mechanism that would be known to one skilled in the art.

The vehicular caddy 10 may also include a securing means for stabilizing the storage facility 20. The securing means include fasteners known to those ordinarily skilled in the art. For example, the securing means include adhesives, straps, belts, and hook and loops. The present invention utilizes existing storage cavities, such as seatback pockets or pouches, door pockets or pouches, existing beverage holders, seatback handles, and any other cavity found in vehicles. For an example of a securing means, the storage facility 20 can include a strap that wraps around a headrest, seat, door, or back of an existing storage cavity and the base 30 aids in supporting the weight of the storage facility 20. Alternatively, the storage facility 20 can include an adhesive so the storage facility 20 can be affixed to a headrest, seat, door, or back of an existing storage cavity.

The base 30 can be inserted into an existing storage cavity. The base 30 can be fabricated to a specific size to fill the void in the existing storage cavity so that it will securely insert within the cavity thereby minimizing the lateral and vertical motions of the base 30 relative to the cavity when a vehicle moves or passes over bumps, potholes, etc. The base 30 can also be securely inserted into a cavity by fabricating the base 30 with expandable capabilities, such as being fabricated as an inflatable cylinder or other geometric shape or made with expanding foam, to fill the void in an existing storage cavity. The expansion can be achieved with shape materials that can be compressed when force (such as hand pressure) is applied and expands when released, with air pumping, spring loaded internal mechanism, and similar. The base 30 can be fabricated in any shape to fill the void in an existing storage cavity.

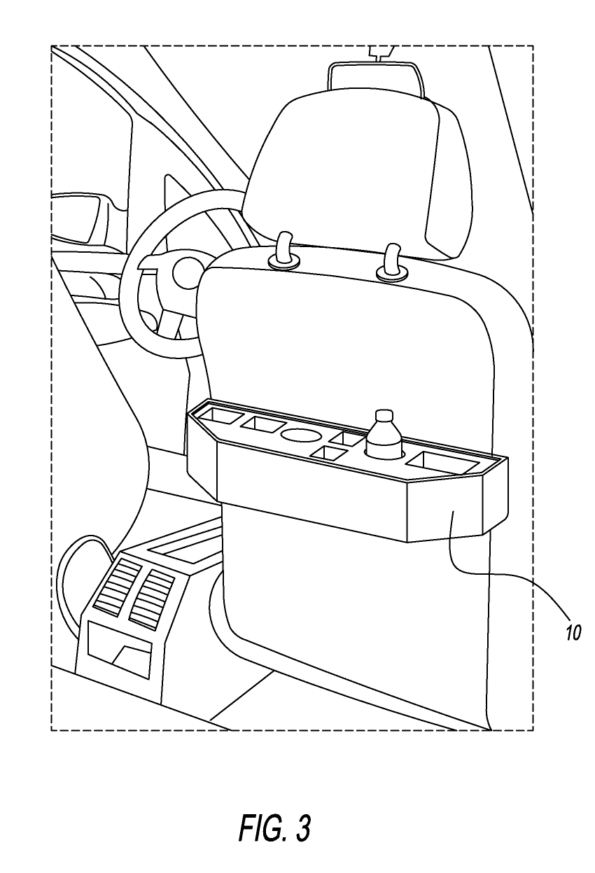

FIG. 3 illustrates an embodiment of the present invention that utilizes the seatback pocket of a seat in a vehicle to secure the vehicle caddy. While FIG. 3 illustrates the vehicular caddy 10 securely inserted in the seat back pocket of a passenger seat in an automobile, the present invention can also be used in the seat back pocket of the driver seat, or any other seat in a vehicle. Also, the present invention is not limited to motor vehicles, and can be used in any vehicle, such as airplanes, boats, trains, etc., that have cavities suitable for supporting the vehicular caddy 10 of the present invention.

In another embodiment, illustrated on FIG. 4, the vehicular caddy 80 comprises a base 100 extending from storage facility 90. The base 100 is configured to fit in the head rest area of a vehicle seat, for example in the space formed between the bottom of the headrest, the top of the seatback, and the two headrest supports. In such a configuration, the supports of the headrest prevent the vehicular caddy 80 from sliding laterally, while the headrest can be pushed down to compress base 100 for additional stability in the vertical and lateral directions.

The base 30, 76, 100 can also have an internal cavity for storage.

The base 30, 76, 100 can comprise various apertures (e.g., slots, round howls, shelves, etc., to allow additional storage of personal belongings.)

The vehicular caddy 10 may also include a covering. The covering can be made from any material that achieves the desired surface texture, feel, perception, moisture and temperature resistance, including, without limitation, different types of textiles, fabrics, laminate, wood, metal, plastic, acrylic, rubber, faux or real leather, or combinations thereof.

The base 30 and storage facility 20 can be made from any material that can be formed to achieve the desired shape, size, density, rigidity, strength, water resistance temperature insulation, and other characteristics. Examples of such materials include foam, ceramics, metal, wood, plastic, composite, fiberglass, corrugated, rubber, graphite, acrylic, or combinations thereof. Different types of foam include polyethylene foam, polypropylene foam, polystyrene foam, dry fast foam, closed cell foam, memory foam, rebond foam, supreem foam, latex rubber foam, high resilience foam, evlon foam, and high density foam.

Various materials or combinations of materials for the base 30 and storage facility 20 and for the covering may be used to achieve various desired properties, such as thermal insulation, sound absorption, vibration reduction, water resistance or proofing, high level of surface friction to ensure secure gripping and other characteristics that will be known to those skilled in the art.

When the base 30 is securely inserted in a cavity, the base 30, securely supports the storage facility 20 by preventing the storage facility 20 from moving vertically or laterally as the vehicle moves. The storage facility 20 and the base 30 can be fabricated, machined or molded as one unit. The base 30 and storage facility 20 can also be fabricated, machined or molded as separate units. In the instances where the storage facility 20 and the base 30 are fabricated as two separate pieces, the two pieces can be either permanently attached together, by gluing, adhesion, melting, bolting, riveting, or any other attachment method known to one skilled in the art. In the alternative, the storage facility 20 and base 30 may be removably (or partially removably) attached to each other using various attachment mechanisms, such as hook and loop, friction fit, interference fit, clips, pins, hinges, etc.

The attachment mechanism can be configured to allow the storage facility 20 to be positioned at a different angle relative to the base 30 to accommodate different orientations of cavities used to secure the vehicle caddy. For example, when secured in a seat back pocket of a vehicle seat, the attachment mechanism can be a hinge mechanism that permits vertical angular adjustment of the storage facility 20 relative to the base 30 when the seat back changes the angle of recline.

The above described invention offers a number of advantages to passengers of vehicles, such as automobiles, planes, trains, buses, and boats. In addition to serving as a device to securely store or hold personal belongings when traveling, the present invention can be removed from one vehicle and used in another vehicle.

We claim:

1. A vehicular storage system, comprising:
a storage facility for securing chattels; and
a base;
wherein the base is configured to be securely inserted into an opening;
wherein the storage facility is secured to the base; and
wherein the base securely supports the storage facility when the base is securely inserted into the opening.

2. The vehicular storage system of claim 1, further comprising a thermal system for regulating the temperature of the chattels.

3. The vehicular storage system of claim 2, wherein the thermal system comprises a thermoelectric element and a means for supplying power to the thermoelectric element.

4. The vehicular storage system of claim 2, wherein the thermal system comprises a means for coupling the thermal system with a vehicle heating and cooling system.

5. The vehicular storage system of claim 1, further comprising an electric supply system comprising an electric connector; wherein the electric supply system allows a user to operate or charge electronic devices by coupling the electronic devices to the electric connector.

6. The vehicular storage system of claim 5, wherein the electric supply system is configured to electrically connect to and utilize a vehicle's electric system.

7. The vehicular storage system of claim 5, wherein the electric supply system is configured to electrically connect to and utilize at least one battery.

8. The vehicular storage system of claim 5, wherein the electric supply system is configured to electrically connect to and utilize a vehicle's electric system as a primary power source and is also configured to electrically connect to and utilize at least one battery as a secondary power source in the event the vehicle's electric system stops supplying power.

9. The vehicular storage system of claim 1, wherein the storage facility includes at least one aperture.

10. The vehicular storage system of claim 9, wherein the base extends downward from the storage facility; and wherein the opening is a backseat pocket of a vehicle seat.

11. The vehicular storage system of claim 10, wherein the base and the storage facility are configured to allow vertical angular adjustment of the storage facility relative to the base to accommodate different seatback recline positions.

12. The vehicular storage system of claim 9, wherein the base extends downward from the storage facility; and wherein the opening is a cup holder.

13. The vehicular storage system of claim 9, wherein the base extends downward from the storage facility; and wherein the opening is a cavity in a vehicle door armrest.

14. The vehicular storage system of claim 9, wherein the storage facility comprises a dispenser.

15. The vehicular storage system of claim 9, wherein the storage facility comprises a tray.

16. The vehicular storage system of claim 9, further comprising a securing means for stabilizing the storage facility.

17. The vehicular storage system of claim 9, wherein the base includes a swivel means to allow the adjustment of the angle of the storage facility.

18. The vehicular storage system of claim 9, wherein the base extends in a horizontal plane from the storage facility; and wherein the opening is a space formed between a vehicle's seatback and a seat's head rest.

19. The vehicular storage system of claim 9, wherein the storage facility comprises a cover; wherein a user can access the aperture when the cover is open and cannot access the aperture when the cover is closed.

20. The vehicular storage system of claim 19, wherein the cover comprises a non-slip surface.
